(19) United States
(12) Patent Application Publication
(10) Pub. No.: US 2008/0150433 A1
(43) Pub. Date: Jun. 26, 2008

(54) BACKLIGHT CONTROL UNIT AND BACKLIGHT CONTROL METHOD

(75) Inventors: Masaki TSUCHIDA, Tokyo (JP); Ken Ito, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/947,493

(22) Filed: Nov. 29, 2007

(30) Foreign Application Priority Data
Dec. 26, 2006 (JP) P2006-350395

(51) Int. Cl. H05B 37/02

(52) U.S. Cl. 315/154

(57) ABSTRACT

According to one embodiment, a light emitting portion of a backlight control unit is a direct lighting type. Accordingly, a light emission intensity of all over the light emitting portion cannot be measured by disposing an optical sensor at a portion as a conventional way. However, in the backlight control unit, a light emission control with high accuracy is realized while suppressing a variation between areas on a basis of a measurement of the light emission intensity of all over the light emitting portion, because an optical sensor detects each light source, a measuring device measures the light emitting intensity thereof, and a backlight control portion performs a control of the light emission intensity of each light source based on a measurement result of the measuring device.

### CROSS-REFERENCE TO RELATED APPLICATIONS

This application is based upon and claims the benefit of priority from Japanese Patent Application Publication No. P2006-350395, filed Dec. 26, 2006, the entire contents of which are incorporated herein by reference.

### BACKGROUND

1. Field

One embodiment of the invention relates to a backlight control unit and a backlight control method.

2. Description of the Related Art

At present, there is one in which light emission intensity of a light source is measured by using an optical sensor, and controls of white points and luminance characteristics are performed by using a measurement result thereof as a backlight control unit used for a liquid crystal TV and so on. The above-stated conventional backlight control unit is a whole surface lighting type by means of a light guide plate method, in which the measurement of the light emission intensity becomes possible by disposing the optical sensor at a portion of a light guide plate, and the measurement of the light emission intensity is enabled even when plural light sources are used.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary exploded perspective view showing a liquid crystal panel unit according to a first embodiment of the invention;

FIG. 2 is an exemplary perspective view showing a schematic configuration of a light source unit of the liquid crystal panel unit shown in FIG. 1 in the first embodiment;

FIG. 3 is an exemplary plan view of the light source unit shown in FIG. 2 in the first embodiment;

FIG. 4 is an exemplary block diagram showing a schematic configuration of a backlight control unit in the first embodiment;

FIG. 5 is an exemplary block diagram showing an internal configuration of a backlight control portion of the backlight control unit shown in FIG. 4 in the first embodiment;

FIG. 6 is an exemplary flowchart showing a procedure of a light emission control in the backlight control unit in FIG. 5 in the first embodiment;

FIG. 7 is an exemplary plan view showing a light source unit in a second embodiment; and

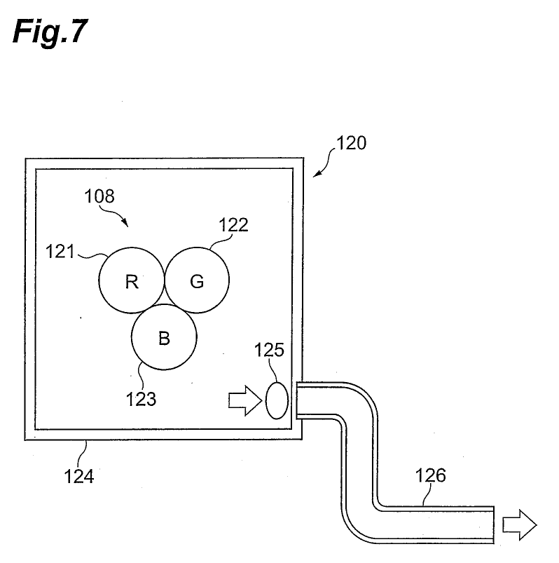

FIG. 8 is an exemplary block diagram showing a schematic configuration of a backlight control unit in the second embodiment.

### DETAILED DESCRIPTION

Various embodiments according to the invention will be described hereinafter with reference to the accompanying drawings. In general, according to one embodiment of the invention, a backlight control unit according to the present invention, includes: a light emitting device in which a light source is disposed by each of plural divided areas; a measuring device detecting light of the light source of the light emitting device, and measuring light emission intensity of the light source; and a control device controlling the light emission intensity of the light source of the light emitting device based on a measurement result of the measuring device.

Or, in general, according to one embodiment of the invention, a backlight control method according to the present invention, includes: detecting light of a light source of a light emitting device from the light emitting device in which the light sources are disposed by each of plural divided areas, and measuring the light emission intensities of the light sources by a measuring device; and controlling the light emission intensity of the light sources of the light emitting device based on a measurement result of the measuring device by a control device.

### First Embodiment

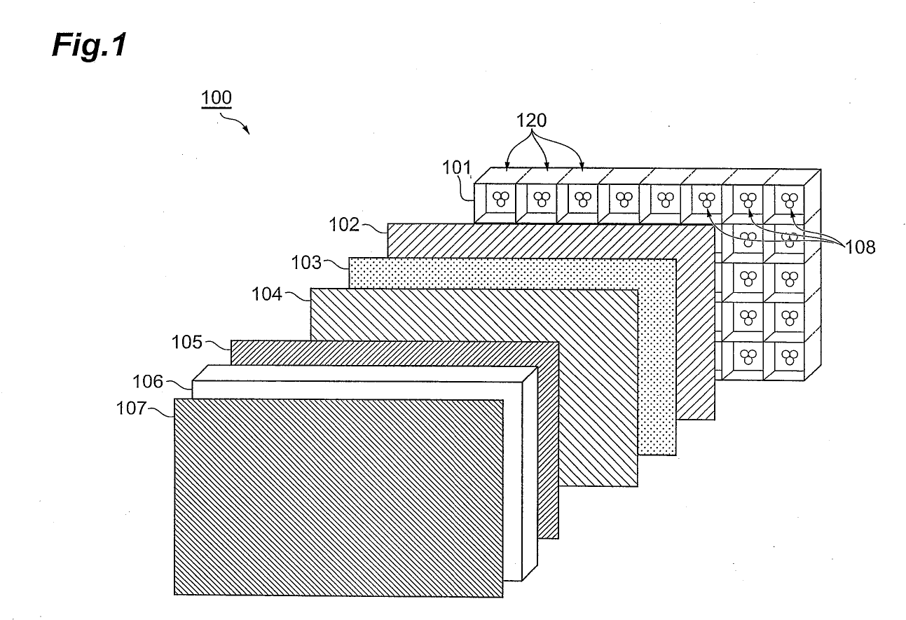

A liquid crystal panel unit 100 according to a first embodiment of the present invention is used for, for example, a liquid crystal television and so on, and has a light emitting portion 101, a pair of diffuser plates 102, 104 sandwiching a prism sheet 103 disposed at a front surface of the light emitting portion 101, and a pair of polarizing plates 105, 107 sandwiching a liquid crystal 106 disposed at a front surface of the front side diffuser plate 104, as shown in FIG. 1.

Incidentally, in general, the light emitting portion 101, the prism sheet 103, and the pair of diffuser plates 102, 104 are called as a backlight unit as a whole. Besides, the liquid crystal 106 and the pair of polarizing plates 105, 107 disposed at the front surface of the backlight unit is called as a liquid crystal panel portion as a whole. A general liquid crystal television is constituted by the backlight unit and liquid crystal panel portion as stated above.

The light emitting portion (light emitting device) 101 of the liquid crystal panel unit 100 has a panel shape, and constituted by plural light source units 120 disposed in a matrix state (for example, 5×7). Each light source unit 120 is surrounded on every side by a barrier rib 124 extending in an overlapping direction with the diffuser plate 102 and so on. Accordingly, the light emitting portion 101 is divided into plural areas by the barrier rib 124.

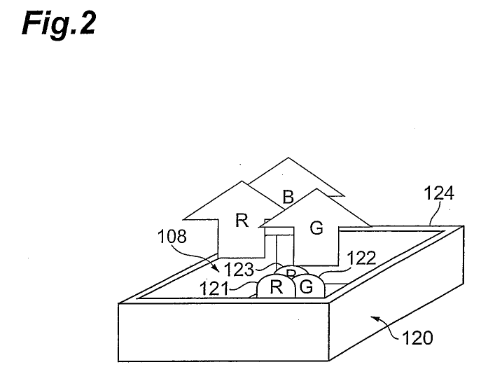

A light source 108 constituted by three LEDs 121, 122 and 123 of RGB three primary colors are disposed at each of plural areas of the light emitting portion 101 as shown in FIG. 2. Namely, the light source 108 is constituted by the red LED 121, green LED 122, and blue LED 123, and light is radiated from a front surface while mixing these colors. The light emitting portion 101 emits light from the whole surface by the above-stated plural light sources 108, and the light emitting portion 101 irradiates the light from a rear surface of the above-stated liquid crystal panel portion, to be a direct lighting type backlight unit.

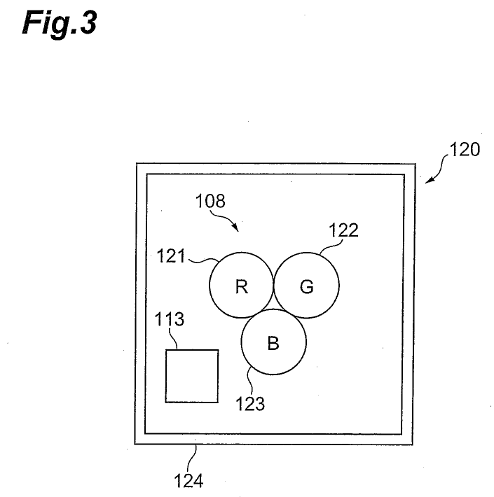

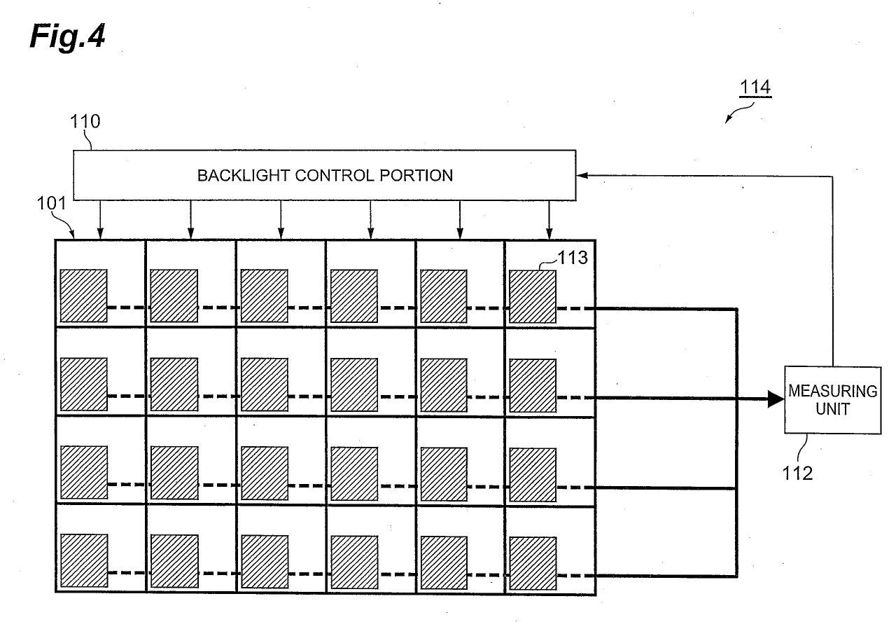

Besides, an optical sensor 113 (for example, a photo diode) is disposed at a position capable of detecting the light emission of the light source 108 at each area of the light emitting portion 101, as shown in FIG. 3. These optical sensors 113 are connected to a measuring unit 112 as shown in FIG. 4. Incidentally, wirings between the optical sensors 113 and the measuring unit 112 are preferable to be laid at a rear surface of the light emitting portion 101.

This measuring unit 112 is a portion to receive an output of the optical sensor 113 and to measure the light emission intensity of the light source 108 at each area. A measuring device in the present invention is constituted by this measuring unit 112 and the optical sensors 113.

The light emission intensity of the light source 108 measured at the measuring unit 112 is transmitted to a backlight control portion (control unit) 110. This backlight control portion 110 is a portion lighting each light source 108 sequentially from an end when the light emission intensity of the light source 108 of the light emitting portion 101 is measured. Besides, the backlight control portion 110 is a portion controlling the light emission intensity of the light source 108 of the light emitting portion 101 based on a measurement result measured by the above-stated measuring device.

A backlight control unit 114 in the present invention is constituted by the light emitting portion 101, the measuring unit 112 having the optical sensors 113, and the backlight control portion 110 shown in FIG. 4.

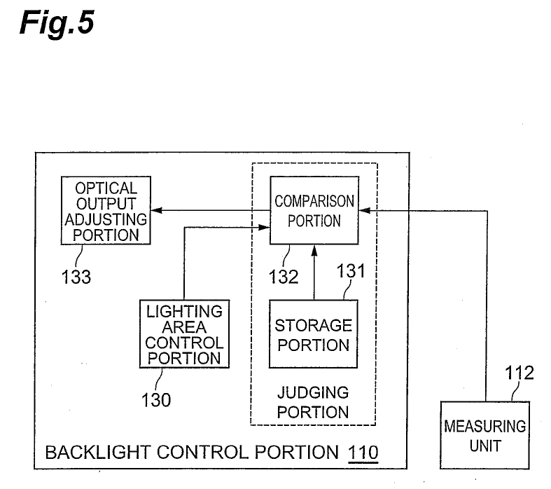

Next, the backlight control portion 110 is described in more detail with reference to FIG. 5.

As shown in FIG. 5, the backlight control portion 110 is constituted by including a lighting area control portion 130, a storage portion 131, a comparison portion 132, and an optical output adjusting portion 133.

A reference value of the light emission intensity of each light source 108 of the light emitting portion 101 (for example, an initial value of the light emission intensity at the time of shipping) is stored in the storage portion 131. The comparison portion (comparison device) 132 is a portion to compare the measurement result of each light source 108 accepted from the above-stated measuring unit 112, and the reference value of the light emission intensity of the corresponding light source 108 stored in the storage portion 131, and to judge whether the light emission intensity of the light source 108 at the measurement time reaches a predetermined level or not (enough or not). A judging device (judging portion) in the present invention is constituted by this comparison portion 132 and the storage portion 131.

The lighting area control portion 130 is a portion to notify the comparison portion 132 of the measurement result accepted by the comparison portion 132 from the measuring unit 112, concerning to which light source 108 of which area the measurement result belongs. For example, when the lighting area control portion 130 lights the light source 108 of a specified area (specified color), the light area control portion 130 notifies identification information of the area to the comparison portion 132.

The optical output adjusting portion (optical output adjusting device) 133 increases the light emission intensity of the light source 108 of the area which is judged that the light emission intensity does not reach the above-stated predetermined level (insufficient) by the comparison portion 132, based on a judgment result of the comparison portion 132. More concretely, the optical output adjusting portion 133 increases the light emission intensity (luminance) by adjusting a pulse width of the corresponding light source 108.

As it is described hereinabove, each light source 108 of the light emitting portion 101 is sequentially lighted (namely, in time division) by the lighting area control portion 130, and therefore, the light emission intensity is also measured in time division by the measuring unit 112.

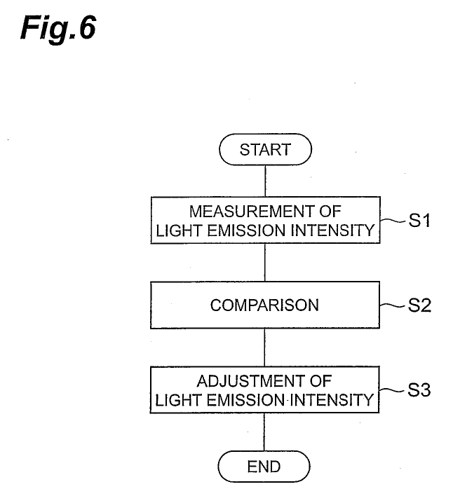

Next, a procedure of light emission control in the above-stated backlight control unit 114 is described with reference to a flowchart in FIG. 6.

When the light emission of the light emitting portion 101 is controlled, at first, the light source 108 at a predetermined area is lighted by the lighting area control portion 130 of the backlight control portion 110, the light emission of the light source 108 is detected by the optical sensor 113 of the corresponding area, and the light emission intensity of the light emission is measured by the measuring unit 112 (block 1).

Subsequently, the comparison portion 132 of the backlight control portion 110 accepts the light emission intensity of the light source 108 measured by the measuring unit 112, and the comparison portion 132 extracts the corresponding reference value from the storage portion 131, to perform a comparison between these (block 2).

The optical output adjusting portion 133 accepts a comparison result (namely whether the light emission intensity of the corresponding light source 108 reaches the predetermined level or not, and a difference thereof) from the comparison portion 132, increases the intensity of the light source 108 only for the difference when the light emission intensity does not reach the predetermined level (block 3), and the control flow ends.

As it is described hereinabove in detail, the light emitting portion 101 of the backlight control unit 114 is a direct lighting type. Accordingly, the light emission intensity of all over the light emitting portion 101 can not be measured even though the optical sensor is disposed at a portion as a conventional way. However, in the backlight control unit 114, the optical sensors 113 detect the respective light sources 108, the measuring unit 112 measures the light emission intensity, and the backlight control portion 110 performs the control of the light emission intensities of the respective light sources 108 based on the measurement result of the measuring unit 112. Consequently, the light emission control with high accuracy is realized while suppressing a variation between each area on a basis that the light emission intensity of all over the light emitting portion 101 is measured.

Besides, it is in a mode in which the measuring device measures the light emission intensity of each of the plural light sources 108, sequentially emitting light by each area, in time division, and therefore, it is possible to efficiently measure the plural light sources 108 of the light emitting portion 101 by one measuring device. Further, it is in a mode in which the light source 108 is constituted by three LEDs 121, 122, and 123 composed of RGB three primary colors, and therefore, it is possible to realize a white light source, and in addition, it is possible to emit light of the RGB three primary colors in monochrome if necessary.

Incidentally, the measuring device may measure by sequentially lighting red, green, and blue of the three LEDs 121, 122, and 123 in time division when each light source 108 is measured in time division. In this case, it is possible to measure the pure light emission intensity of a wavelength of each color LED efficiently. Besides, all of the three colors can be measured by one optical sensor 113, and therefore, a cost reduction is realized.

Besides, it is in a mode in which the backlight control portion 110 has the judging device including the storage portion 131 and the comparison portion 132, and the optical output adjusting portion 133 increasing the light emission intensity of the light source 108 which is judged that the light emission intensity thereof does not reach the predetermined level by the judging device. Accordingly, the adjustment of the light emission intensity is performed only for the light source 108 of which light emission intensity does not actually reach the predetermined level, and therefore, an efficient light emission control can be performed, and in addition, it is possible to easily judge the light emission intensity of the light source 108 by a simple comparison with the reference value.

### Second Embodiment

Next, a backlight control unit 114A which is in a different mode from the above-stated backlight control unit 114 is described.

In the light source unit 120 in the present embodiment, an optical fiber 126 is attached to the barrier rib 124 as an optical waveguide. This optical fiber 126 derives light of the optical source 108 from inside of an area of the light source unit 120 toward outside. Incidentally, a spherical lens (condenser element) 125 is attached to an end portion of the optical fiber 126 at the light source unit 120 side, and the light of the light source 108 is efficiently condensed into inside of the optical fiber 126 by this spherical lens 125.

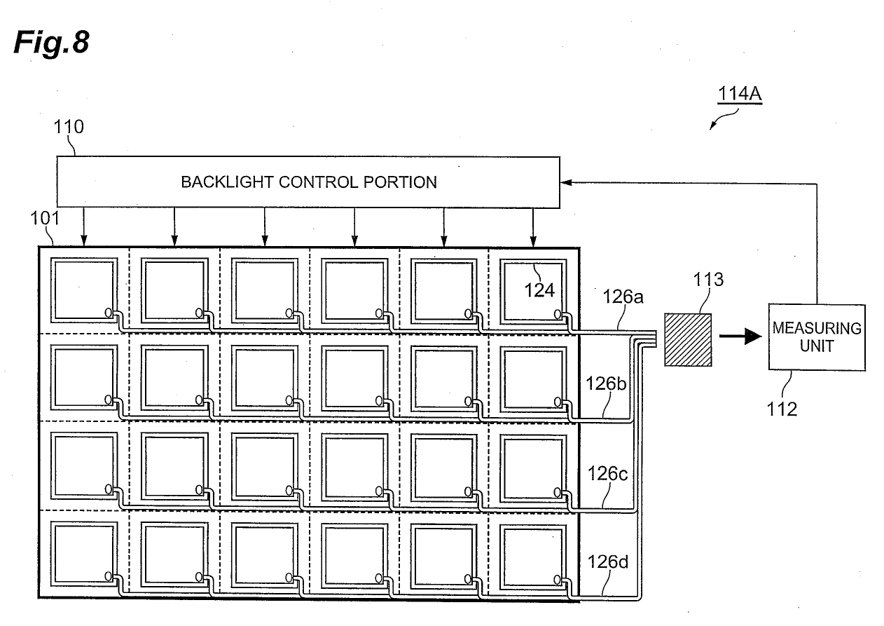

Plural optical fibers 126 (for example, reference numerals 126a, 126b, 126c, and 126d) attached to the respective light source units 120 are connected to the optical sensor 113 as shown in FIG. 8, and the light derived from each of the optical fibers 126 is converted into corresponding electrical signals by this optical sensor 113.

An output from the optical sensor 113 is measured as the light emission intensity of each light source 108 by the measuring unit 112 as same as the first embodiment. A measurement result is transmitted to the backlight control portion 110 as same as the first embodiment, and the light emission control of the light emitting portion 101 is performed by the backlight control portion 110.

The optical fibers 126, the optical sensor 113, and the measuring unit 112 functioning as the measuring device measure the light emission intensity of each light source 108, and the backlight control portion 110 performs the control of the light emission intensity of each light source 108 based on the measurement result of the measuring unit 112 following the control flow as same as the light emission control in the first embodiment (refer to FIG. 6), also in the backlight control unit 114A in the present embodiment. Accordingly, the light emission control with high accuracy is realized while suppressing the variation between areas on a basis that the light emission intensity of all over the light emitting portion 101 is measured.

Besides, in the backlight control unit 114A according to a second embodiment, the measuring device has a constitution including the optical fibers 126, the optical sensor 113 and the measuring unit 112, and therefore, it is possible to derive the light of the light source not as the electrical signal but as the light as it is, and to efficiently convert the derived light into the electrical signal by one optical sensor. Consequently, the light emission control by fewer optical sensors 113 than the first embodiment becomes possible, and the number of parts and a cost can be drastically reduced. Incidentally, it is also possible to change into a mode in which plural optical sensors 113 are used accordingly.

Further, the spherical lens 125 is attached to the end portion of the optical fiber 126, and therefore, the light intensity propagating through the optical fiber 126 is improved, and an improvement of a measurement accuracy by the measuring device is realized. Incidentally, the optical waveguide to be used is not limited to the optical fiber, but the optical fiber is preferable because of a point that it is easy to obtain, a point that it is space saving, a point that it has flexibility, and so on.

The present invention is not limited to the above-described embodiments, and various modifications are possible. For example, in the above-stated embodiment, the light source 108 of the light source unit 120 is constituted by the red LED 121, green LED 122 and blue LED 123, and the light is radiated while mixing these LEDs 121, 122 and 123, but it may be in a mode in which RGB are evenly mixed by using a fine optical system inside of the light source unit 120 if necessary. Besides, a distance from positions of the respective LEDs 121, 122 and 123 to the diffuser plate 102 may be secured for a certain distance, and these colors may be mixed to be white color. Further, the mixing of color may be performed by combining the above-stated methods. Incidentally, a light source of a white LED package having red, green and blue may be disposed at each area instead of the three LEDs.

When the LEDs are used as the light source, it is possible to drive the light sources of the three primary colors respectively, and therefore, it becomes possible to measure each color in a state in which they emit light independently when the light emission intensity is measured, and an influence by other colors can be removed. Namely, it is possible to measure by lighting each color sequentially when the measurement is necessary.

Besides, a distance between adjacent light source units 120 with each other is not limited to the distance in which the light source units 120 are disposed closely, but it can be selected accordingly within a range keeping a distance in which the lights are displayed so that there is no discontinuity in adjacent lights on both sides when the light reaches the liquid crystal panel.

Further, a measurement timing thereof is suitable at the time when the liquid crystal panel unit 100 is powered on/off, when a regular TV display is performed in color sequential, or when a user uses an adjusting function in which the user can adjust directly.

In the above-stated embodiments, three LEDs composed of RGB three primary colors are used as the light source, but the number thereof can increase/decrease accordingly as long as plural optical elements are used. As the optical element and the light source, an LD (laser diode element), an EL (electroluminescence element) and so on can be adopted in addition to the LED (light emitting diode element). However, when a white light source which cannot reproduce each color independently such as a white LED reproducing two-colored or multi-colored white, an organic EL, and an inorganic EL are used, it is possible to perform an adjustment, of the light emission intensity of each area, in particular, a luminance adjustment although it is not possible to measure the light emission intensity by sequentially lighting colors such as the color sequential.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A backlight control unit, comprising:
a light emitting device in which a light source is disposed by each of plural divided areas;
a measuring device detecting light of the light source of said light emitting device, and measuring light emission intensity of the light source; and
a control device controlling the light emission intensity of the light source of said light emitting device based on a measurement result of said measuring device.

2. The backlight control unit according to claim 1,
wherein said measuring device measures the light emission intensity of each of the plural light sources sequentially emitting light by each area, in time division.

3. The backlight control unit according to claim 1,
wherein the light source is constituted by any optical elements of plural LEDs composed of RGB three primary colors, EL, or LD.

4. The backlight control unit according to claim 3,
wherein said measuring device measures the light emission intensity of each of the plural optical elements lighting sequentially, in time division.

5. The backlight control unit according to claim 1,
wherein said measuring device includes:
an optical waveguide deriving the light of the light source from the area where the light source is disposed; and
a measuring unit measuring the light derived by the optical waveguide.

6. The backlight control unit according to claim 5, further comprising:
a condenser element attached to an end portion of the optical waveguide at the area side.

7. The backlight control unit according to claim 5,
wherein the optical waveguide is an optical fiber.

8. The backlight control unit according to claim 1,
wherein said control device includes:
a judging device judging whether the light emission intensity of the light source reaches a predetermined level or not from the measurement result of said measuring device; and
an optical output adjusting device increasing the light emission intensity of the light source judged that the light emission intensity does not reach the predetermined level by the judging device.

9. The backlight control unit according to claim 8,
wherein the judging device includes:
a storage portion storing a reference value of the light emission intensity of the light source; and
a comparison device performing the judgment whether the light emission intensity of the light source reaches the predetermined level or not by a comparison between the reference value stored in the storage portion and the measurement result of said measuring device.

10. A backlight control method, comprising:
detecting light of a light source of a light emitting device from the light emitting device in which the light sources are disposed by each of plural divided areas, and measuring the light emission intensity of the light source by a measuring device; and
controlling the light emission intensity of the light sources of the light emitting device based on a measurement result of the measuring device by a control device.
